(19) United States
(12) Patent Application Publication
(10) Pub. No.: US 2025/0022059 A1
(43) Pub. Date: Jan. 16, 2025

(54) SYSTEMS, METHODS, AND APPARATUS FOR MONITORING, ADJUSTING, AND MIRRORING ELECTRONIC TRANSACTIONS ACROSS TRANSACTION ENVIRONMENTS

(71) Applicant: Addigence Corporation, New York, NY (US)

(72) Inventor: Kenton Broadfoot Kilmer, New York, NY (US)

(21) Appl. No.: 18/711,874

(22) PCT Filed: Nov. 18, 2022
(86) PCT No.: PCT/US22/50504

§ 371 Date: May 20, 2024

Related U.S. Application Data
(60) Provisional application No. 63/281,056, filed on Nov. 18, 2021.

(51) Int. Cl. G06Q 40/06

(52) U.S. Cl. CPC G06Q 40/06

(57) ABSTRACT

Systems, apparatus, methods, and articles of manufacture provide for mirroring financial transactions and portfolios across transaction environments. A platform is provided to mirror transactions from a manager environment to an investor environment, providing a streamlined process for managers to track record creation and asset gathering. A financial asset management platform is provided in which participating account managers never touch investors' money.

### CROSS-REFERENCE TO RELATED APPLICATIONS

The present application claims the benefit of priority of U.S. Provisional Patent Application No. 63/281,056 filed Nov. 18, 2021, entitled “Systems, Methods, and Apparatus for Monitoring, Adjusting, and Mirroring Electronic Transactions across Transaction Environments,” which is incorporated by reference in the present application.

### FIELD OF THE INVENTION

Embodiments of the present invention are directed to electronic transaction management systems and methods, in particular, systems facilitating management of financial asset management over electronic communications networks.

### BACKGROUND

Despite the strong interest in financial asset management (e.g., systems for hedge fund management, personal investment management), current systems have failed to overcome technical hurdles that provide high barriers to entry in terms of cost and compliance. As a result, the modern hedge fund industry, for example, is dominated by a handful of established fund managers and platforms. The technical hurdles thus limit the ability of potential decision makers (e.g., fund managers) from providing alternative transaction strategies and executions in a way that may be easily identified and monitored. Limited to a small pool of service providers, current systems similarly limit the ability of individuals from easily identifying, monitoring, and participating in transactions suggested by any alternative decision makers. Such technical issues limit the ability to configure and host asset management platforms for potential managers and investors. Prior art systems also fail to provide for a secure way to process payments and to ensure the appropriate allocation of fees to remote participants based on performance in mirrored transaction environments.

### BRIEF DESCRIPTION OF THE DRAWINGS

An understanding of embodiments described in this disclosure and many of the related advantages may be readily obtained by reference to the following detailed description when considered with the accompanying drawings, of which:

FIGS. 1A and 1B are a diagram of an example user interface for an electronic transaction management system according to various embodiments of the present invention;

FIGS. 2A, 2B, and 2C are a diagram of an example user interface for an electronic transaction management system according to various embodiments of the present invention;

FIG. 3 is a diagram of an example user interface for an electronic transaction management system according to various embodiments of the present invention;

FIG. 4 is a diagram of an example user interface for an electronic transaction management system according to various embodiments of the present invention;

FIG. 5A is a diagram of an electronic transaction management system according to an embodiment of the present invention; and

FIG. 5B is a diagram of an electronic transaction management system according to an embodiment of the present invention;

FIG. 6 is a diagram of a controller device according to an embodiment of the present invention;

FIG. 7 is a flowchart of a method according to an embodiment of the present invention; and

FIG. 8 is a flowchart of a method according to an embodiment of the present invention.

### DETAILED DESCRIPTION

The inventor for this application has recognized that, in accordance with some embodiments described in this disclosure, certain types of individuals would find it advantageous to have access to a financial transaction platform and set of tools allowing for the mirroring of financial transaction strategies and/or executions proposed by any one or more participating managers. Further, by offering a solution to emerging managers to easily demonstrate their track record, be benchmarked to indices/peer, gather assets for their strategy, and/or charge fees on their performance (without actively managing user funds, in accordance with some embodiments), the inventive systems, methods, and apparatus effectively allow investors to discover, monitor, and bet on the effectiveness of participating managers in a controlled, liquid, and transparent environment.

According to some embodiments, a platform configured to mirror transactions from a manager environment to an investor environment provides a streamlined process for manager track record creation and asset gathering.

In accordance with some embodiments, a financial asset management platform is provided in which participating account managers never touch investors' money.

In one or more embodiments, a participating manager submits a trade or otherwise manages an investment portfolio, and the platform mirrors the indicated positions in the accounts of investors following or otherwise participating in that manager's strategy.

In accordance with some embodiments of the present invention, one or more systems, apparatus, methods, articles of manufacture, and/or computer readable media (e.g., a non-transitory computer readable memory storing instructions for directing a processor) provide for one or more of:
a) facilitating asset management by a first user for a first portfolio; and/or
b) based on the asset management of the first portfolio by the first user, automatically mirroring asset management of a second portfolio of a second user.

In accordance with some embodiments of the present invention, one or more systems, apparatus, methods, articles of manufacture, and/or computer readable media (e.g., a non-transitory computer readable memory storing instructions for directing a processor) provide for one or more of:
a) identifying manager investment position information associated with a portfolio manager;
b) facilitating the association of one or more clients with the portfolio manager and/or with an investment strategy of the portfolio manager;
c) identifying a client having an investment account associated with the portfolio manager; and/or
d) mirroring the manager investment position information to the investment account of the client.

In accordance with some embodiments of the present invention, one or more systems, apparatus, methods, articles of manufacture, and/or computer readable media (e.g., a non-transitory computer readable memory storing instructions for directing a processor) provide for one or more of:
a) identifying a manager investment position of a portfolio manager, the manager investment position corresponding to a financial security;
b) receiving (e.g., from the portfolio manager) an instruction to modify the manager investment position;
c) in accordance with the instruction, modifying the manager investment position corresponding to the financial security;
d) identifying a client portfolio associated with the portfolio manager, the client portfolio having a client investment position in the financial security; and/or
e) after (or upon, in response to, or substantially concurrently with) modifying the manager investment position, modifying the client investment position in the financial security.

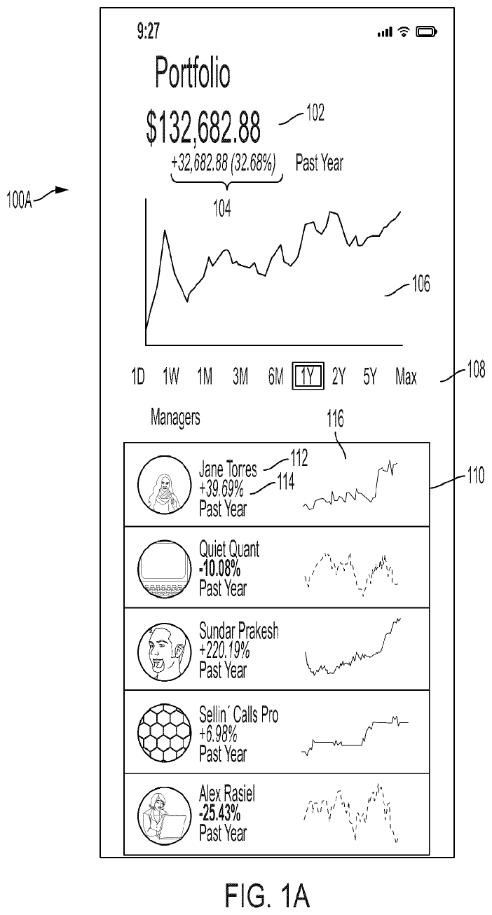

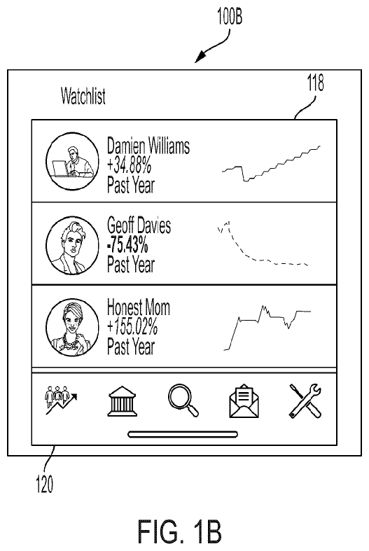

As depicted in FIGS. 1A, 1A, 2A, 2B, 2C, 3, and 4 and in FIGS. 1-28B of U.S. Provisional Patent Application No. 63/281,056 ('056 application) incorporated by reference herein, in accordance with some embodiments, certain functionality may be implemented using a user interface of a software application for mobile devices (e.g., smartphones, tablets, laptop computers) and/or for other types of computing devices (e.g., desktop computers, dedicated financial services console devices). In some embodiments, a software application may be accessible using an Internet browser (e.g., as a web-based application service).

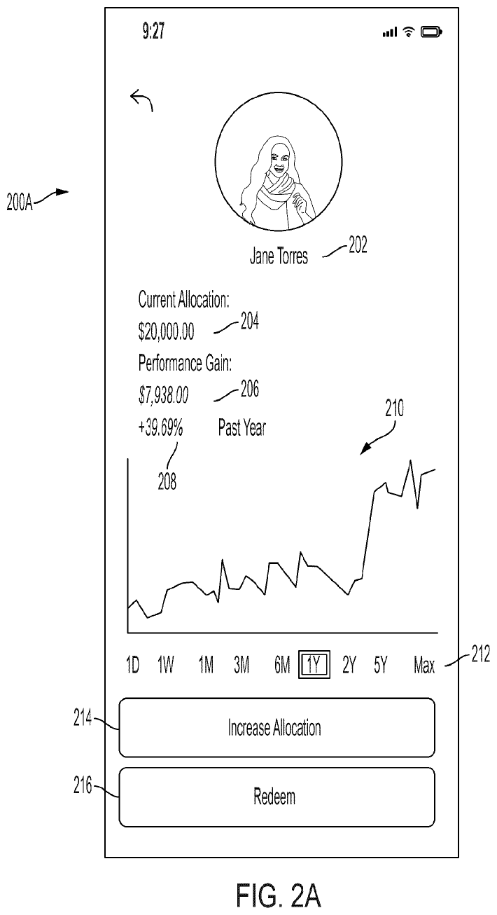

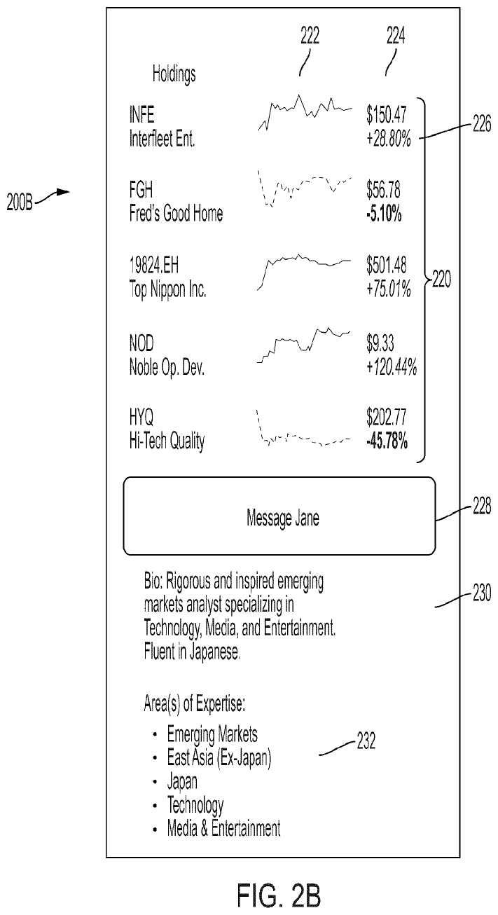

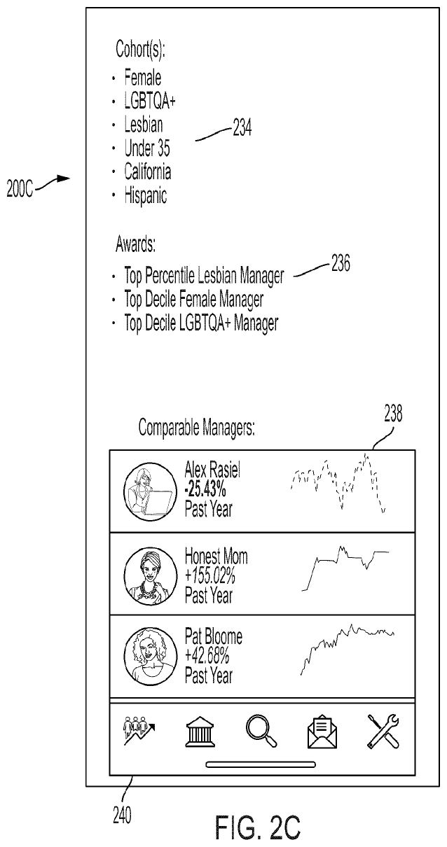

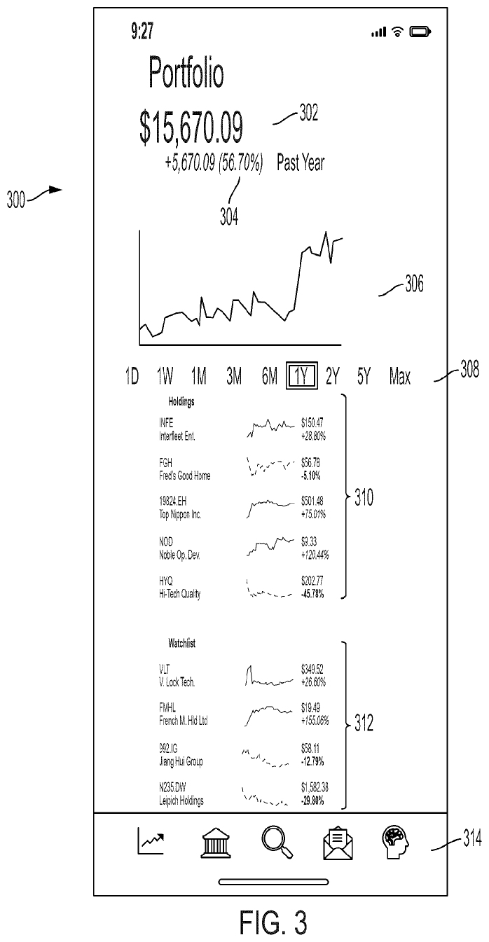

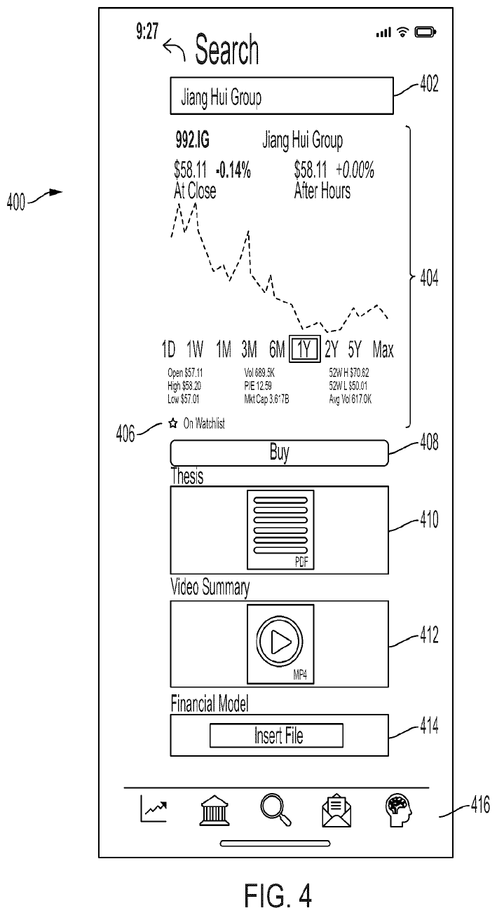

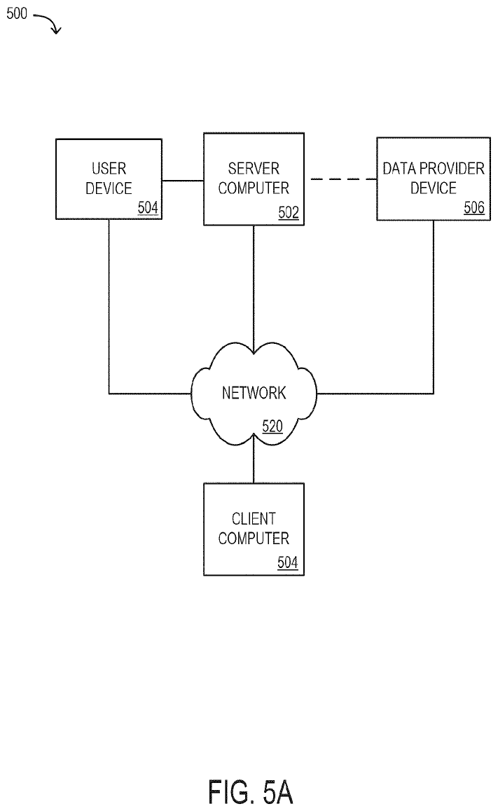

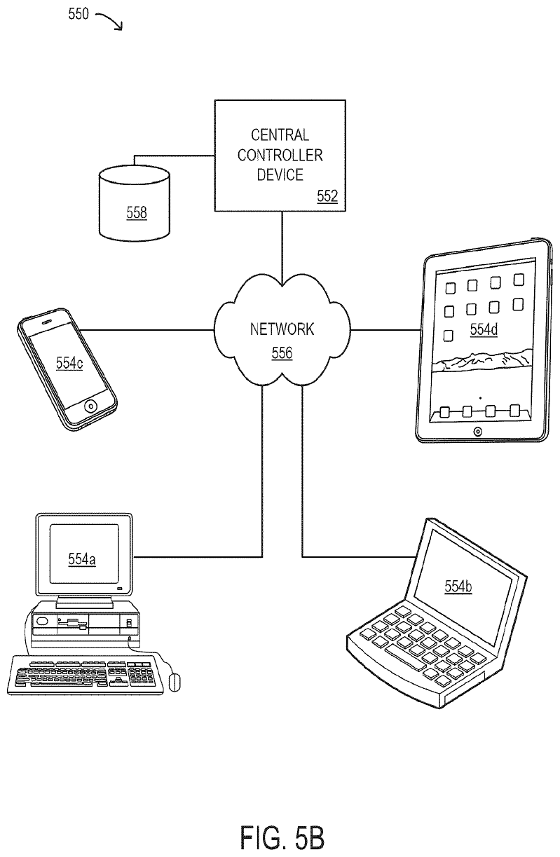

In accordance with some embodiments of the present invention, one or more systems, apparatus, methods, articles of manufacture, and/or computer readable media (e.g., a non-transitory computer readable memory storing instructions for directing a processor) provide for one or more of:
a) providing a client portal user interface (see, e.g., FIG. 1 of the '056 application);
b) providing a user interface for receiving a user ID (e.g., email address), password, and user name for registering a new user (see, e.g., FIGS. 2 and 3 of the '056 application);
c) providing a user interface for receiving a user ID and password for logging in a registered user (see, e.g., FIG. 4 of the '056 application);
d) providing a user interface for authenticating logins (see, e.g., FIGS. 5-7 of the '056 application);
e) providing client portfolio information via a user interface (see, e.g., example user interface 100A and 100B of FIGS. 1A-1B, showing portfolio balance information 102, portfolio change information 104, portfolio performance information 106 for one or more periods, associated portfolio manager information 110 (including associated portfolio manager name 112, portfolio manager portfolio change information 114, and/or portfolio manager portfolio performance information 116), manager watchlist information 118 for managers whose performance indicators the client is monitoring, and/or application toolbar 120);
f) providing client ledger information for a client account (e.g., deposit transactions and/or portfolio manager allocation transactions) via a user interface (see, e.g., FIG. 9 of the '056 application);
g) adding and/or transferring out funds associated with a client account via a user interface (see, e.g., FIG. 9 of the '056 application (“Add Funds” and “Transfer to Your Bank” buttons));
h) providing a user interface for searching for portfolio managers using keywords and/or predetermined filters (see, e.g., FIG. 10A-10B of the '056 application);
i) providing portfolio manager information via a user interface (e.g., example user interfaces 200A, 200B, and 200C of FIGS. 2A-2C, showing example portfolio manager name 202, user allocation amount 204 associated with a portfolio manager, portfolio change information 206 and 208, portfolio performance information 210, reporting period options 212, portfolio holdings information 220 (including respective holding performance information 222 and price 224), portfolio manager biographical information 230, 232, 234, and 236, information about comparable managers 238, and/or application toolbar 240);
j) providing a user interface for increasing and/or redeeming an allocation of client funds to a portfolio manager (see, e.g., example “Increase Allocation” button 214 and “Redeem” button 216 of user interface 200A of FIG. 2A));
k) providing a user interface for sending messages to a portfolio manager (see, e.g., “Message Jane” button 228 of example interface 200B of FIG. 2B);
l) providing portfolio manager search results with a respective selectable interface element corresponding to each search result (see, e.g., FIGS. 12 and 13 of the '056 application) wherein selecting a search results causes the system to present portfolio manager information for the selected portfolio manager (see, e.g., FIGS. 2A-2C);
m) providing a user interface for reviewing, managing, and responding to messages to the client (e.g., system messages, transaction messages, style drift messages, and/or portfolio manager messages) (see, e.g., FIG. 14 of the '056 application); and/or
n) providing a user interface for setting up and/or viewing client information, such as but not limited to desired cohort exposure information, desired strategy exposure information, system preferences, and/or banking information (see, e.g., FIG. 15 of the '056 application).

In accordance with some embodiments of the present invention, one or more systems, apparatus, methods, articles of manufacture, and/or computer readable media (e.g., a non-transitory computer readable memory storing instructions for directing a processor) provide for one or more of:
a) providing a portfolio manager user interface (see, e.g., FIG. 16 of the '056 application);
b) providing a user interface for receiving a user ID (e.g., email address), password, and user name for registering a new portfolio manager (see, e.g., FIGS. 17 and 18 of the '056 application);
c) providing a user interface for receiving a user ID and password for logging in a registered portfolio manager (see, e.g., FIG. 19 of the '056 application);
d) providing a user interface for authenticating logins (see, e.g., FIGS. 20-22 of the '056 application);
e) providing portfolio manager portfolio information via a user interface (see, e.g., example user interface 300 of FIG. 3, showing portfolio balance information 302, portfolio change information 304, portfolio performance information 306 for one or more periods 308, portfolio holdings information 310, security watchlist information 312 for securities whose performance indicators the portfolio manager is monitoring, and/or application toolbar 314);
f) providing portfolio manager ledger information for a portfolio manager account (e.g., performance fee transactions, dividend transactions, security buy transactions, security sell transactions, and/or deposit transactions) via a user interface (see, FIG. 24 of the '056 application);
g) adding and/or transferring out funds associated with a portfolio manager account via a user interface (see, e.g., FIG. 24 of the '056 application (“Add Funds” and “Transfer to Your Bank” buttons));
h) providing a user interface for searching for securities using keywords (see, e.g., FIG. 25 of the '056 application);
i) providing information about financial securities via a user interface (e.g., example user interface 400 of FIG. 4, showing example financial security 402, price, performance, and/or volume information 404, thesis information 410, summary information 412, and/or financial model information 414 (e.g., in the form of uploaded text, video/audio, and other file formats), one or more buttons 408 facilitating purchase of financial securities (e.g., a “Buy” button), and/or application toolbar 416);
j) providing a user interface for reviewing, managing, and responding to messages to the client (e.g., system messages, transaction messages, style drift messages, and/or client messages) (see, e.g., FIG. 27 of the '056 application); and/or
k) providing a user interface for setting up and/or viewing portfolio manager information, such as but not limited to biographical information, areas of expertise, associated cohort information, performance fee information, awards, system preferences, and/or banking information (see, e.g., FIG. 28A-28B of the '056 application).

In accordance with some embodiments of the present invention, one or more systems, apparatus, methods, articles of manufacture, and/or computer readable media (e.g., a non-transitory computer readable memory storing instructions for directing a processor) provide for one or more of:
a) determining a portfolio configuration, wherein the portfolio configuration comprises a set of securities and their respective weighting based on a portfolio manager's portfolio (e.g., looking up a portfolio's securities and weightings based on positions/relative value in the portfolio manager's portfolio);
b) determining that a user has allocated an amount of funds to the portfolio configuration;
c) purchasing or otherwise acquiring, using the allocated amount of funds, the securities according to the respective weightings defined by the portfolio configuration to create a mirrored user portfolio that mirrors the portfolio configuration;
d) in response to changes to the portfolio configuration (e.g., periodically, from time to time, in accordance with a predetermined schedule, etc.), modifying the securities and/or their respective weightings in the mirrored user portfolio in accordance with the changes to the portfolio configuration;
e) calculating a performance fee based on performance of the mirrored user portfolio (e.g., based on a predetermined performance fee percentage applied to a gain in mirrored user portfolio value); and/or
f) distributing a performance fee from the mirrored user portfolio (e.g., by liquidating an equally weighted percentage of securities in the mirrored user portfolio).

The following describes an example process for determining and distributing performance fees in accordance with some embodiments of the present invention. The description of the example process uses the following defined terms:
“PM”=A portfolio manager on an example platform for mirroring portfolios.
“AL”=An allocator on the example mirrored portfolio platform.
“STRAT”=The securities and their respective weightings as decided by the PM's portfolio.
“t0”=Start date and time of fee collection algorithm.
“t1”=t0+90 days
“PMv0”=Value of PM's portfolio at t0
“PMv1”=Value of PM's portfolio at t1
“Lv0”=Value of AL's portfolio at t0
“ALv1”=Value of AL's portfolio at t1
“G”=Any non-negative value of ALv1-ALv0.
“ALDG”=The performance displayed to the AL; ALDG=G−G*PF
“PF”=Performance fee (30%)

The example process includes the following example steps:

Step 1—After the PM funds their account and builds a portfolio of securities, the STRAT is created. At t0, the AL allocates to the PM's STRAT, the funds of the AL's allocation directly acquire the STRAT's securities in their respective weightings (quantities) for the benefit of the AL's account.

Step 2—As time passed from t0 to t1, ALv0 will change in value to ALv1. If ALv1>ALv0, then a G, gain, is realized. A PF is calculated on a rolling basis which is equal to 30% of G. The ALDG is calculated by G-PF. In the AL's allocation to the PM, the ALDG is displayed to the AL.

Step 3—At t1, if the G is a non-negative number, then the algorithm liquidates an equally weighted percentage of securities in the AL portfolio, as guided by the STRAT at t0, to a total of G*PF.

Step 4—The funds gained through the liquidation of the securities in Step 3 are distributed to the Ledgers/Cash Accounts of the PM and the platform (e.g., in ratio 2:1, i.e., two thirds distributed to the PM and one third retained by the platform).

Step 5—After the distribution of the PF to the PM (and platform), as outlined in Step 4, the ALDG+ALv0=ALv1. ALv1 becomes the initial value, i.e., ALv0, for the subsequent cycle of Steps 1 through 4.

In one embodiment, if, in a process similar to that outlined above in Steps 1-5, AL redeems their allocation to the STRAT before t1, then the PF may be taken from the proceeds of the sold securities and distributed in the ratios/splits between the PM and the Platform as outlined in Step 4.

In some embodiments, as the PM manages the STRAT over the lifetime of the AL's allocation to the STRAT, any changes in the STRAT will be passed through to the security selection on a percentage basis reflected in the STRAT.

According to some embodiments, factional shares (similar to Stock Slices by Charles Schwab), may be used if the AL's allocation is smaller than 500× the closing price of the most expensive security of the STRAT at t0.

In one hypothetical example, a platform in accordance with one embodiment allows an individual who has demonstrated a unique aptitude for investing in a niche market or asset class (e.g., Chinese equities, cryptocurrencies, silver futures, etc.) to build a track record of their success to be able to show to potential investors and employers.

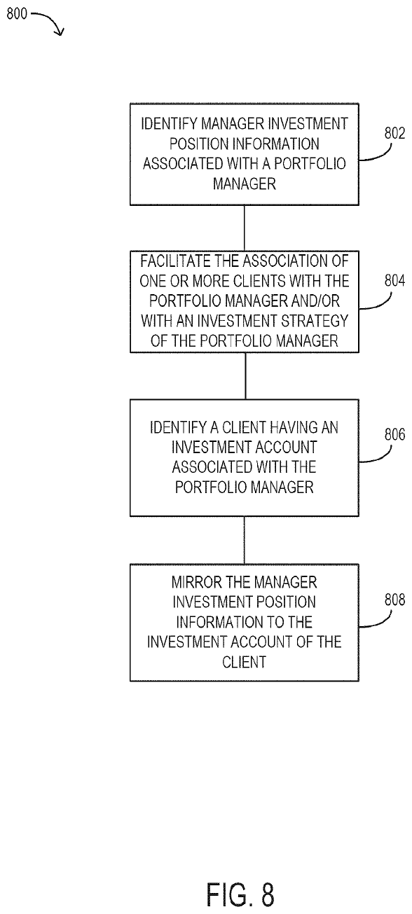

According to some embodiments, passthrough gains associated with a portfolio may be indicated to users after fees (e.g., performance fees allocated to a portfolio manager), as described in the example process above. For example, performance gains indicated to a user via a portfolio view in a mobile application (see, e.g., FIG. 8A) may reflect performance after any performance fees are liquidated by the system. In other embodiments, performance metrics may reflect any amounts deducted, transferred, or liquidated for performance fees and/or other types of fees.

In some embodiments, the system may provide for monitoring and detecting style drift in a portfolio manager's portfolio. For example, in response to identifying that a portfolio manager's current configuration for a portfolio varies from the investment style(s) associated with that portfolio, the system may send a message to participating users who have allocated funds to that portfolio configuration. In this way, users may be notified if the portfolio is no longer in line with their intended investment strategy. Similarly, users may receive notifications and/or establish predetermined rules and/or thresholds for automatic transactions processes to take place, such as, without limitation, stop loss thresholds.

According to some embodiments, investor users may receive an indication if a portfolio manager has achieved a predetermined benchmark. In this way, gamification of certain actions and/or performance metrics may be introduced to the platform to increase user interest.

According to some embodiments, processes described in this disclosure may be performed and/or implemented by and/or otherwise associated with one or more specialized and/or computerized processing devices, specialized computers, computer terminals, computer servers, computer systems and/or networks, and/or any combinations thereof. In some embodiments, methods may be embodied in, facilitated by, and/or otherwise associated with various input mechanisms and/or interfaces.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described in this disclosure.

The methods described in this disclosure may be performed, for example, by a server computer (e.g., a dedicated portfolio management controller configured to provide the special functions described in this disclosure). It should be noted that although some of the steps of such methods may be described as being performed by a server computer while other steps are described as being performed by another computing device (e.g., a mobile device with a smartphone application), any and all of the steps may be performed by a single computing device which may be a mobile device, desktop computer, or another computing device. Further, any steps described herein as being performed by a particular computing device may, in some embodiments, be performed by a human or another computing device as appropriate.

FIG. 5a depicts a block diagram of an example system 500 according to some embodiments. The system 500 may comprise one or more user devices 504 in communication with a controller or server computer 502 via a network 520. Typically, a processor (e.g., one or more microprocessors, one or more microcontrollers, one or more digital signal processors) of a user device 504 or server computer 502 will receive instructions (e.g., from a memory or like device), execute those instructions, and perform one or more processes defined by those instructions. Instructions may be embodied, for example, in one or more computer programs and/or one or more scripts.

In some embodiments a server computer 502 and/or one or more of the user devices 504 stores and/or has access to information useful for performing one or more functions of a user device 504, as described in this disclosure. Such information may include one or more of: (i) user data (e.g., client and/or manager data), (ii) financial account data, (iii) portfolio data, (iv) transaction data, and/or (v) securities data).

According to some embodiments, any or all of such data may be stored by or provided via one or more optional third-party data devices 506 of system 500. A third-party data device 506 may comprise, for example, an external hard drive or flash drive connected to a server computer 502, a remote third-party computer system for storing and serving data for use in performing one or more functions described in this disclosure, or a combination of such remote and/or local data devices. In one embodiment, one or more companies and/or end users may subscribe to or otherwise purchase data from a third party and receive the data via the third-party data device 506.

In some embodiments, the server computer 502 may comprise one or more electronic and/or computerized controller devices such as computer servers communicatively coupled to interface with the user devices 504 and/or third-party devices 506 (directly and/or indirectly). The server computer 502 may, for example, comprise PowerEdge™ M910 blade servers manufactured by Dell, Inc. of Round Rock, TX which may include one or more Eight-Core Intel® Xeon® 7500 Series electronic processing devices. According to some embodiments, the server computer 502 may be located remote from the user devices 504. The server computer 502 may also or alternatively comprise a plurality of electronic processing devices located at one or more various sites and/or locations.

According to some embodiments, the server computer 502 may store and/or execute specially programmed instructions to operate in accordance with one or more embodiments described in this disclosure. The server computer 502 may, for example, execute one or more programs that facilitate management and coordination of portfolio manager configurations for holding securities (and respective weightings) with mirrored portfolio holdings held by other users, via the network 560.

In some embodiments, a user device 504 may comprise a desktop computer or a workstation computer, and/or a mobile or portable computing device such as a smartphone, a laptop or other portable computing device, and an application for creating, joining, and/or managing portfolios and user information is stored locally on the user device 504, which may access information stored on, or provided via, the server computer 502. In another embodiment, the server computer 502 may store some or all of the program instructions and the user device 504 may execute the application remotely via the network 520 and/or download from the server computer 502 (e.g., a web server) some or all of the program code for executing one or more of the various functions described in this disclosure.

In one embodiment, a server computer may not be necessary or desirable. For example, some embodiments described in this disclosure may be practiced on one or more devices (e.g., a desktop computer with a stand-alone application) without a central authority. In such an embodiment, any functions described herein as performed by a server computer and/or data described as stored on a server computer may instead be performed by or stored on one or more such devices, such a smartphone or tablet computer. Additional ways of distributing information and program instructions among one or more user devices 504 and/or server computers 502 will be readily understood by one skilled in the art upon contemplation of the present disclosure.

FIG. 5B depicts a block diagram of an example system 550 according to some embodiments. The system 550 may comprise one or more example user devices 554a-d in communication with an example controller device 552 via a network 556. According to some embodiments, the example controller device 554 may be in communication with one or more databases 558.

In some embodiments, the example controller device 552 may comprise one or more electronic and/or computerized controller devices such as computer servers communicatively coupled to interface with the example user devices 554a-d (directly and/or indirectly). The example controller device 554 may, for example, comprise one or more devices as discussed with respect to server computer 502. According to some embodiments, the example controller device 554 may be located remote from the example user devices 554a-d. The example controller device 552 may also or alternatively comprise a plurality of electronic processing devices located at one or more various sites and/or locations.

The example user devices 554a-d, in some embodiments, may comprise any types or configurations of mobile electronic network, user, and/or communication devices that are or become known or practicable. The example user devices 554a-d may, for example, comprise wireless smartphones such as an iPhone™ smartphone manufactured by Apple, Inc. or Samsung Galaxy™ phones manufactured by Samsung Electronics Co., Ltd. The example user device 554a may, as depicted for example, comprise a personal or desktop computer (PC), the example user device 554B may comprise a laptop computer, the example user device 554c may comprise a smartphone, and the example user device 554d may comprise a tablet computer.

Typically, a processor (e.g., one or more microprocessors, one or more microcontrollers, one or more digital signal processors) of an example user device 554a-d or example controller device 552 will receive specially programmed instructions (e.g., from a memory or like device), execute those instructions, and perform one or more processes defined by those instructions. Instructions may be embodied for example, in one or more computer programs and/or one or more scripts.

In some embodiments an example controller device 552 and/or one or more of the example user devices 554a-d stores and/or has access to data useful for receiving portfolio management data from and/or transmitting such data to an example user device 554a-d. Such information may include one or more of: (i) client/investor data, (ii) manager data, (iii) portfolio data, and (iv) financial asset data.

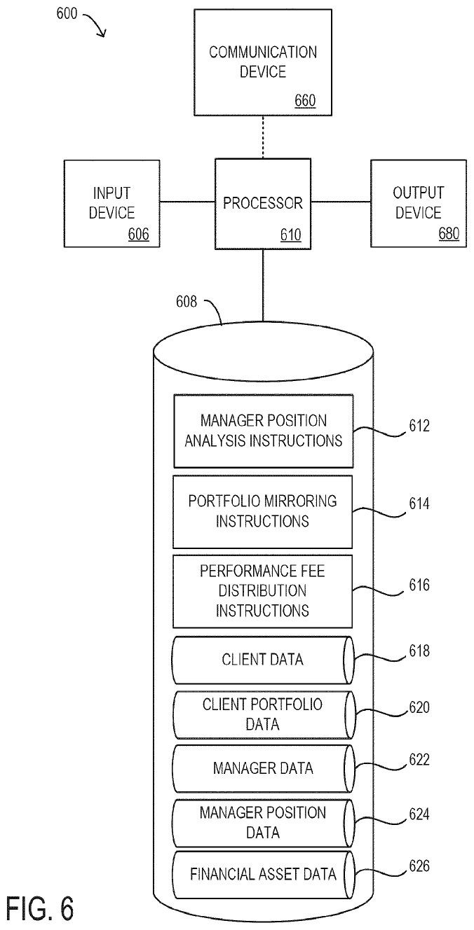

Turning to FIG. 6, a block diagram of an apparatus 600 according to some embodiments is shown. In some embodiments, the apparatus 600 may be similar in configuration and/or functionality to any of the user devices 504, user devices 554a-d, server computer 502, and/or the central controller device 552. The apparatus 600 may, for example, execute, process, facilitate, and/or otherwise be associated with methods described in this disclosure.

In some embodiments, the apparatus 600 may comprise a processor 610, an input device 606, an output device 680, a communication device 660, and/or a memory device 608. According to some embodiments, any or all of the components of the apparatus 600 may be similar in configuration and/or functionality to any similarly named and/or numbered components described herein. Fewer or more components and/or various configurations of the components may be included in the apparatus 600 without deviating from the scope of embodiments described herein.

According to some embodiments, the processor 610 may be or include any type, quantity, and/or configuration of electronic and/or computerized processor that is or becomes known. In some embodiments, the processor 610 may comprise multiple inter-connected processors, microprocessors, and/or micro-engines. According to some embodiments, the processor 610 (and/or the apparatus 600 and/or portions thereof) may be supplied power via a power supply (not shown), such as a battery, an alternating current (AC) source, a direct current (DC) source, an AC/DC adapter, solar cells, and/or an inertial generator. In the case that the apparatus 600 comprises a server, such as a blade server, necessary power may be supplied via a standard AC outlet, power strip, surge protector, and/or uninterruptible power supply (UPS) device.

In some embodiments, the input device 606 and/or the output device 680 are communicatively coupled to the processor 610 (e.g., via wired and/or wireless connections and/or pathways) and they may generally comprise any types or configurations of input and output components and/or devices that are or become known, respectively. The input device 606 may comprise, for example, a keyboard that allows an operator of the apparatus 600 to interface with the apparatus 600. In some embodiments, the input device 606 may comprise a sensor configured to provide information to the apparatus 600 and/or the processor 610. The output device 680 may, according to some embodiments, comprise a display screen and/or other practicable output component and/or device. The output device 680 may, for example, provide a portfolio management module to a user (e.g., via a website and/or smartphone app accessible using a user device). According to some embodiments, the input device 606 and/or the output device 680 may comprise and/or be embodied in a single device, such as a touch-screen monitor.

In some embodiments, the communication device 660 may comprise any type or configuration of communication device that is or becomes known or practicable. The communication device 660 may, for example, comprise a network interface card (NIC), a telephonic device, a cellular network device, a router, a hub, a modem, and/or a communications port or cable. In some embodiments, the communication device 660 may be coupled to provide data to a user device (not shown in FIG. 6), such as in the case that the apparatus 600 is utilized to serve a portfolio management application to one or more users as described in this disclosure. The communication device 660 may, for example, comprise a cellular telephone network transmission device that sends signals to a user device. According to some embodiments, the communication device 660 may also or alternatively be coupled to the processor 610. In some embodiments, the communication device 660 may comprise an IR, RF, Bluetooth™, and/or Wi-Fi® network device coupled to facilitate communications between the processor 610 and another device (such as a user device and/or a third-party device).

The memory device 608 may comprise any appropriate information storage device that is or becomes known or available, including, but not limited to, units and/or combinations of magnetic storage devices (e.g., a hard disk drive), optical storage devices, and/or semiconductor memory devices, such as RAM devices, read only memory (ROM) devices, single data rate random access memory (SDR-RAM), double data rate random access memory (DDR-RAM), and/or programmable read only memory (PROM).

The memory device 608 may, according to some embodiments, store one or more of: manager position analysis instructions 612, portfolio mirroring instructions 614, performance fee distribution instructions 616, client data 618, client portfolio data 620, manager data, 622, manager position data 624, and/or financial asset data 626.

In some embodiments, the manager position analysis instructions 612 may be utilized by the processor 610 to monitor and/or identify a portfolio configuration for one or more managers and/or to output an indication of such portfolio configuration (e.g., an allocation of value across one or more financial assets), such as displaying information to a user via the output device 680 and/or the communication device 660.

According to some embodiments, the manager position analysis instructions 612 may be operable to cause the processor 610 to process manager data 622, manager position data 624, and/or financial asset data 626, in order to determine whether certain information associated with a manager meets one or more criteria for updating and/or reconfiguring one or more client portfolios. Manager data 622, manager position data 624, and/or financial asset data 626, received via the input device 606, accessed from the memory device 608, and/or received via the communication device 660 may, for example, be analyzed, sorted, filtered, and/or otherwise processed by the processor 610 in accordance with the manager position analysis instructions 612.

In some embodiments, the portfolio mirroring instructions 614 may be utilized by the processor 610 with client portfolio data 620 and/or financial asset data 626 to output an indication of instructions or other signals for reconfiguring portfolios of one or more client portfolios. In one example, client portfolios associated with a certain manager who was flagged by, analyzed, and/or identified by the manager position analysis instructions 612 may be reconfigured, such as by reallocating value among one or more financial assets of the portfolio to achieve an allocation similar or substantially identical to that of the associated manager (e.g., as determined according to the manager position analysis instructions 612).

In some embodiments, the performance fee distribution instructions 616 may be utilized by the processor 610 with client data 618, client portfolio data 620, manager data, 622, manager position data 624, and/or financial asset data 626, to determine a performance fee corresponding to a reconfiguration of a client's portfolio. Various examples of determining such fees are discussed in this disclosure. The performance fee distribution instructions 616 may comprise instructions for transmitting an indication of a determined performance fee to one or more users (e.g., via the communication device 660 and/or output device 680) and/or storing an indication of the performance fee (e.g., in client portfolio data 620).

Any or all of the exemplary instructions and data types described herein, and other practicable types of data may be stored in any number, type, and/or configuration of memory devices that is or becomes known. The memory device 608 may, for example, comprise one or more data tables or files, databases, table spaces, registers, and/or other storage structures. In some embodiments, multiple databases and/or storage structures (and/or multiple memory devices 608) may be utilized to store information associated with the apparatus 600. According to some embodiments, the memory device 608 may be incorporated into and/or otherwise coupled to the apparatus 600 (e.g., as shown) or may simply be accessible to the apparatus 600 (e.g., externally located and/or situated).

Any or all the methods described in this disclosure may involve one or more interface(s). One or more of such methods may include, in some embodiments, providing an interface (e.g., the example user interfaces disclosed in the present application and/or in the '056 application) by and/or through which a user may manage user information, search for portfolio managers and/or securities, manage portfolios and/or allocations of funds, and/or provide and/or redeem funds (e.g., adding and/or withdrawing funds from an account). Although certain types of information are illustrated in the example interfaces, those skilled in the art will understand that the interfaces may be modified in order to provide for additional types of information and/or to remove some of the illustrated types of information, as deemed desirable for a particular implementation.

Any processes described in this disclosure do not necessarily imply a fixed order to any depicted actions, steps, and/or procedures, and embodiments may generally be performed in any order that is practicable unless otherwise and specifically noted.

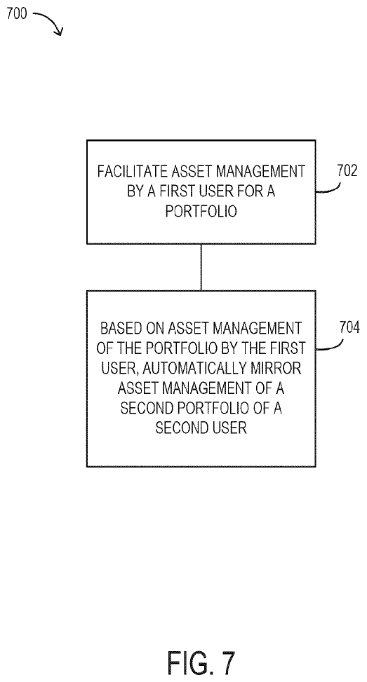

Referring now to FIG. 7, a flow diagram of a method 700 according to some embodiments is shown. The method 700 may be performed, for example, by a server providing a web-based application and/or by a smartphone or executing a downloadable mobile application.

According to some embodiments, the method 700 may comprise a step to facilitate asset management by a first user for a portfolio, at 702. In one example, the first user may be a manager setting up a portfolio that may be followed by other users (e.g., clients, investors), such as by purchasing and/or selling financial assets to establish a portfolio, or specifying a portfolio allocation by designating numbers of shares in one or more financial assets (without necessarily buying or selling those assets).

According to some embodiments, the method 700 may comprise a step to automatically mirror asset management of a second portfolio of a second user, based on asset management of the portfolio by the first user (e.g., using portfolio mirroring instructions 614), at 704. In one example, when a manager changes a portfolio allocation (at 702), the asset management of a manager's portfolio is then automatically mirrored to the asset management of a portfolio of a client investor who is following the manager using a portfolio management platform service.

Referring now to FIG. 8, a flow diagram of a method 800 according to some embodiments is shown. The method 800 may be performed, for example, by a server providing a web-based application and/or by a smartphone or executing a downloadable mobile application.

According to some embodiments, the method 800 may comprise a step to identify manager investment position information (e.g., using manager position data 624), at 802. The method 800 may further comprise a step to facilitate the association one or more clients with the portfolio manager and/or with an investment strategy of the portfolio manager, at 804. In one example, a client may select (e.g., using a user interface presented in a mobile application or webpage) a manager to follow and/or an investment strategy of the manager to follow.

The method 800 may further comprise a step to identify a client having an investment account associated with the portfolio manager (e.g., after identifying a change in the configuration of the portfolio manager's portfolio), at 806; and mirroring the manager investment position information to the investment account of the client (e.g., using portfolio mirroring instructions 614).

### Interpretation

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (as may be set forth at the beginning of the first page of this disclosure) nor the Abstract (as may be set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

Some embodiments may be associated with a “user device” or a “network device”. As used in this disclosure, the terms “user device” and “network device” may be used interchangeably and may generally refer to any device that can communicate via a network. Examples of user or network devices include a personal computer (PC), a workstation, a server, a printer, a scanner, a facsimile machine, a copier, a personal digital assistant (PDA), a storage device (e.g., a disk drive), a hub, a router, a switch, and a modem, a video game console, or a wireless phone. User and network devices may comprise one or more communication or network components.

Some embodiments may be associated with a “network” or a “communication network”. As used in this disclosure, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. In some embodiments, networks may be hard-wired, wireless, virtual, neural, and/or any other configuration or type of network that is or becomes known. Networks may comprise any number of computers and/or other types of devices in communication with one another, directly or indirectly, via a wired or wireless medium such as the Internet, LAN, WAN or Ethernet (or IEEE 802.3), Token Ring, RF, cable TV, satellite links, or via any appropriate communications means or combination of communications means. In some embodiments, a network may include one or more wired and/or wireless networks operated in accordance with any communication standard or protocol that is or becomes known or practicable. Exemplary protocols for network communications include but are not limited to: the Fast Ethernet LAN transmission standard 802.3-2002R published by the Institute of Electrical and Electronics Engineers (IEEE), Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Communication between and/or among devices may be encrypted to ensure privacy and/or prevent fraud in any one or more of a variety of ways well known in the art.

Devices that are in communication with each other need not be in continuous communication with each other, unless expressly specified otherwise. On the contrary, such devices need only transmit to each other as necessary or desirable and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

As used in this disclosure, the term “network component” may refer to a network device, or a component, piece, portion, or combination of a network device. Examples of network components may include a Static Random Access Memory (SRAM) device or module, a network processor, and a network communication path, connection, port, or cable.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described in this disclosure are associated with an “indication”. The term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

“Determining” something may be performed in a variety of manners and therefore the term “determining” (and like terms) includes calculating, computing, deriving, looking up (e.g., in a table, database or data structure), ascertaining, recognizing, and the like.

A “processor” means any one or more microprocessors, Central Processing Unit (CPU) devices, computing devices, microcontrollers, digital signal processors, or like devices. Examples of processors include, without limitation, Intel® Core™ processors by Intel Corporation or M1 processors by Apple, Inc.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate). Where more than one device or article is described in this disclosure (whether or not they cooperate), a single device or article may alternatively be used in place of the more than one device or article that is described. For example, a plurality of computer-based devices may be substituted with a single computer-based device. Accordingly, functionality that is described as being possessed by more than one device or article may alternatively be possessed by a single device or article. The functionality and/or the features of a single device that is described may be alternatively embodied by one or more other devices that are described but are not explicitly described as having such functionality and/or features. Thus, other embodiments need not include the described device itself, but rather can include the one or more other devices that would, in those other embodiments, have such functionality/features.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring nonsimultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

It will be readily apparent that the various methods and algorithms described in this disclosure may be implemented by, e.g., appropriately- and/or specially-programmed general purpose computers and/or computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

Accordingly, a description of a process likewise describes at least one apparatus for performing the process, and likewise describes at least one computer-readable medium and/or computer-readable memory for performing the process. The apparatus that performs a described process may include components and/or devices (e.g., a processor, input and output devices) appropriate to perform the process. A computer-readable medium may store program elements and/or instructions appropriate to perform a described method.

The term “computer-readable medium” refers to any medium that participates in providing data (e.g., instructions or other information) that may be read by a computer, a processor, or a like device. Various forms of computer-readable media may be involved in carrying data, including sequences of instructions, to a processor. For example, sequences of instruction (i) may be delivered from RAM to a processor, (ii) may be carried over a wireless transmission medium, and/or (iii) may be formatted according to any one or more of various known formats, standards, or protocols (some examples of which are described in this disclosure with respect to communication networks).

Computer-readable media may take many forms, including but not limited to, non-volatile media, volatile media, and transmission media. Non-volatile media may include, for example, optical or magnetic disks and other types of persistent memory. Volatile media may include, for example, DRAM, which typically constitutes the main memory for a computing device. Transmission media may include, for example, coaxial cables, copper wire, and fiber optics, including the wires that comprise a system bus coupled to the processor. Transmission media may include or convey acoustic waves, light waves, and electromagnetic emissions, such as those generated during RF and IR data communications. Common forms of computer-readable media include, for example, a floppy disk, a flexible disk, a hard disk, magnetic tape, any other magnetic medium, a CD-ROM, DVD, any other optical medium, a punch card, paper tape, any other physical medium with patterns of holes, a RAM, a PROM, an EPROM, a FLASH-EEPROM, a Universal Serial Bus (USB) memory stick or thumb drive, a dongle, any other memory chip or cartridge, a carrier wave, or any other medium from which a computer can read.

The term “computer-readable memory” may generally refer to a subset and/or class of non-transitory computer-readable medium that does not include intangible or transitory signals, waves, waveforms, carrier waves, electromagnetic emissions, or the like. Computer-readable memory may typically include physical, non-transitory media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, USB devices, any other memory chip or cartridge, and the like.

Where databases are described, it will be understood by one of ordinary skill in the art that (i) alternative database structures to those described may be readily employed, and (ii) other memory structures besides databases may be readily employed. Any illustrations or descriptions of any sample databases presented in this disclosure are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries may be different from those described in this disclosure. Further, despite any depiction of the databases as tables, other formats (including relational databases, object-based models, hierarchical electronic file structures, and/or distributed databases) could be used to store and/or manipulate the described data. Likewise, object methods or behaviors of a database may be used to implement one or more of various processes, such as those described in this disclosure. In addition, the databases may, in a known manner, be stored locally and/or remotely from a device that accesses data in such a database. Furthermore, while unified databases may be contemplated, it is also possible that the databases may be distributed and/or duplicated amongst a variety of devices.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. A portfolio management system comprising:
a portfolio management controller comprising:
a processor; and
a computer-readable memory in communication with the processor, the computer-readable memory storing instructions that when executed by the processor direct the processor to:
identify manager investment position information associated with a portfolio manager;
facilitate the association of one or more clients with an investment strategy of the portfolio manager;
identify a client having an investment account associated with the portfolio manager; and
mirror the manager investment position information to the investment account of the client.

2. The portfolio management system of claim 1, wherein the instructions when executed by the processor further direct the processor to:
determine a performance fee for the portfolio manager; and
allocate the performance fee to the portfolio manager.

3. A method comprising:
identifying manager investment position information associated with a portfolio manager;
facilitating the association of one or more clients with an investment strategy of the portfolio manager;
identifying a client having an investment account associated with the portfolio manager; and
mirroring the manager investment position information to the investment account of the client.

4. The method of claim 3, further comprising:
determining a performance fee for the portfolio manager; and
allocating the performance fee to the portfolio manager.

5. A method comprising:
identifying a manager investment position of a portfolio manager, the manager investment position corresponding to a financial security;
receiving, from a portfolio manager, an instruction to modify the manager investment position;
in accordance with the instruction, modifying the manager investment position corresponding to the financial security;
identifying a client portfolio associated with the portfolio manager, the client portfolio having a client investment position in the financial security; and
in response to modifying the manager investment position, modifying the client investment position in the financial security without requiring intervention of the portfolio manager in the modification of the client investment position.

6. The method of claim 5, further comprising:
determining a performance fee for the portfolio manager; and
allocating the performance fee to the portfolio manager.
